(19) United States
(12) Patent Application Publication
(10) Pub. No.: US 2002/0141392 A1
(43) Pub. Date: Oct. 3, 2002

(54) Gateway apparatus and voice data transmission method

(76) Inventors: Yasuo Tezuka, Yokohama (JP); Yuichiro Chikamatsu, Kawasaki (JP)

Correspondence Address: Rosenman & Colin LLP, 575 Madison Avenue, New York, NY, 10022-2585, US

(21) Appl. No.: 09/964,825

(22) Filed: Sep. 27, 2001

(30) Foreign Application Priority Data
Mar. 30, 2001 (JP) 2001-102176

(51) Int. Cl. H04L 12/66

(52) U.S. Cl. 370/352; 370/356

(57) ABSTRACT

In a gateway apparatus which interconnects a first network and a second network, an encoding processing unit receives voice data from the first network and generates encoded voice data from the received voice data. A packet processing unit creates packets of the encoded voice data and transmits the packets to the second network. A network-state estimation unit determines network-state information of the second network. A determination unit controls at least one of the encoding of the encoding processing unit and the packetizing of the packet processing unit based on the network-state information determined by the network-state estimation unit.

### BACKGROUND OF THE INVENTION

1. Field of The Invention

The present invention generally relates to a gateway apparatus and voice data transmission method, and more particularly to a gateway apparatus and voice data transmission method which creates packets of voice data from an existing telephone network and transmits the packets over an IP network.

2. Description of The Related Art

With recent development of IP (Internet protocol) networks, there is a focus of attention given to VoIP (voice over Internet protocol) gateway technology that creates packets of voice data and transmits the packets of voice data over an IP network. It is expected that the use of the VoIP gateway enable the interconnection between the existing PSTN (public switched telephone network) and the IP network. For example, a VoIP gateway apparatus that interconnects the existing PSTN and the IP network is known.

FIG. 1 shows a voice communication network system in which a conventional VoIP gateway apparatus is provided.

In the voice communication network system in FIG. 1, voice data, which is sent by any of subscriber terminals 1a, 1b, 1c and 1d, is transmitted to a conventional VoIP gateway apparatus 3 via an existing PSTN 2. The conventional VoIP gateway apparatus 3 generally includes a CODEC processing unit 4 and an IP packet processing unit 5. The CODEC processing unit 4 receives the voice data from the PSTN 2, and generates encoded voice data from the received voice data. The IP packet processing unit 5 creates IP packets of the encoded voice data from the CODEC processing unit 4, and transmits the IP packets to another VoIP gateway apparatus 7 via an IP network 6. The VoIP gateway apparatus 7 receives the IP packets from the IP network 6, and creates the decoded voice data from the received IP packets. The VoIP gateway apparatus 7 transmits the decoded voice data to any of subscriber terminals 10a, 10b, 10c and 10d via an existing PSTN 9.

In the voice communication network system shown in FIG. 1, a media gateway controller (MGC) 8 is provided to send control instructions to the conventional VoIP gateway apparatus 3 (or the VoIP gateway apparatus 7). In the conventional VoIP gateway apparatus 3, the encoding of the CODEC processing unit 3 and the packetizing of the IP packet processing unit 5 are controlled based on the control instructions received from the MGC 8. For example, the conventional VoIP gateway apparatus 3 determines a CODEC type and an IP-ToS (type of service) based on the control instructions received from the MGC 8.

When transmitting the voice data in the voice communication network system via the IP network 6, it is important to avoid the transmission delay, the packet arrival time fluctuation and the packet loss, which will cause the deterioration of the voice data quality. However, the IP network 6 often employs the voice data transmission services of the best-effort type or the connectionless type. It is difficult for the conventional VoIP gateway apparatus 3 to eliminate the above problems including the transmission delay, the packet arrival time fluctuation and the packet loss.

On the other hand, it is known that the transmission delay, the packet arrival time fluctuation and the packet loss, which will be the causes of the deterioration of the voice data quality, can be eliminated if the IP network is configured to use the guaranty-type or the connection type data transmission services for all of the voice data communications thereof. However, there is the problem that the guaranty-type or the connection type data transmission services degrade the advantageous feature of the IP network that maximizes the utilization of the transmission resources of the IP network.

In order to eliminate the problems of the transmission delay, the packet arrival time fluctuation and the packet loss without degrading the advantageous feature of the IP network, it has been required to carry out the transmission control by always monitoring the invariably changing network states (e.g., the packet arrival time or the congestion condition) of the IP network including the destination subscriber terminals has been required.

As described above, the conventional VoIP gateway apparatus 3 (or the conventional VoIP gateway apparatus 7) performs the transmission control based on the control instructions received from the MGC 8. However, it is very difficult for the MGC 8 to monitor all the network states of the IP network 6 when sending the control instructions to the respective VoIP gateway apparatuses.

### SUMMARY OF THE INVENTION

An object of the present invention is to provide an improved gateway apparatus in which the above-described problems are eliminated.

Another object of the present invention is to provide a gateway apparatus that carries out the voice data transmission, maximizes the utilization of the transmission resources of the IP network, and eliminates the causes of the deterioration of the voice data quality.

Another object of the present invention is to provide a voice data transmission method that carries out the voice data transmission, maximizes the utilization of the transmission resources of the IP network, and eliminates the causes of the deterioration of the voice data quality.

The above-mentioned objects of the present invention are achieved by a gateway apparatus which interconnects a first network and a second network, the gateway apparatus comprising: an encoding processing unit which receives voice data from the first network and generates encoded voice data from the received voice data; a packet processing unit which creates packets of the encoded voice data from the encoding processing unit and transmits the packets to the second network; a network-state estimation unit which determines network-state information of the second network; and a determination unit which controls at least one of the encoding of the encoding processing unit and the packetizing of the packet processing unit based on the network-state information determined by the network-state estimation unit.

The above-mentioned objects of the present invention are achieved by a data transmission method which is performed by a gateway apparatus including an encoding processing unit and a packet processing unit and interconnecting a first network and a second network, the data transmission method comprising the steps of: causing the encoding processing unit to receive voice data from the first network and generate encoded voice data from the received voice data; causing the packet processing unit to create packets of the encoded voice data and transmit the packets to the second network; determining network-state information of the second network; and controlling at least one of the encoding of the encoding processing unit and the packetizing of the packet processing unit based on the network-state information obtained in the generating step.

According to the gateway apparatus and the data transmission method of the present invention, the determination unit can control the encoding of the encoding processing unit and the packetizing of the packet processing unit based on the network-state information of the second network, in a manner that is appropriate for the state of the second network. The gateway apparatus and the data transmission method of the present invention are effective in performing the voice data transmission to maximize the utilization of the transmission resources of the second network and maintain the quality of the voice data at an appropriate quality level without being affected by the network delay or the congestion state, causing the deterioration of the voice data quality.

In the gateway apparatus and the data transmission method of the present invention, the evaluation of the second network state is carried out by any of the various evaluation methods based on the packet loss ratio, the packet arrival time jitter value, the TTL value, and the previous evaluation result. The encoding processing unit and the packet processing unit can respectively perform the encoding of the voice data and the packetizing of the encoded voice data according to a selected one of a plurality of different control parameter levels, which is suited for the current network state of the second network.

### BRIEF DESCRIPTION OF THE DRAWINGS

Other objects, features and advantages of the present invention will become apparent from the following detailed description when read in conjunction with the accompanying drawings.

FIG. 1 is a diagram of a voice communication network system in which a conventional VoIP gateway apparatus is provided.

FIG. 2 is a diagram of a voice communication network system in which the VoIP gateway apparatus according to the invention is provided.

FIG. 3 is a block diagram of one preferred embodiment of the VoIP gateway apparatus of the invention in the voice communication network system.

FIG. 4 is a flowchart for explaining a control process performed by a determination unit of the VoIP gateway apparatus in FIG. 3 based on an estimated packet loss ratio of the IP network.

FIG. 5 is a diagram for explaining a target value of the packet loss ratio.

FIG. 6 is a flowchart for explaining a control process performed by the determination unit of the VoIP gateway apparatus in FIG. 3 based on an estimated packet arrival time jitter of the IP network.

FIG. 7 is a diagram for explaining a target value of the packet arrival time jitter.

FIG. 8A, FIG. 8B and FIG. 8C are diagrams for explaining control parameters including a packet discarding priority level, a packet transmission priority level and a CODEC type.

FIG. 9 is a block diagram of another preferred embodiment of the VoIP gateway apparatus of the invention.

FIG. 10 is a flowchart for explaining a reading process performed by a TTL estimation unit of the VoIP gateway apparatus in FIG. 9.

FIG. 11 is a flowchart for explaining another reading process performed by the TTL estimation unit of the VoIP gateway apparatus in FIG. 9.

FIG. 12 is a flowchart for explaining another reading process performed by the TTL estimation unit of the VoIP gateway apparatus in FIG. 9.

FIG. 13 is a flowchart for explaining a control process performed by the determination unit of the VoIP gateway apparatus in FIG. 9.

FIG. 14 is a diagram for explaining a target value of a hop count.

FIG. 15 is a block diagram of another preferred embodiment of the VoIP gateway apparatus of the invention.

FIG. 16 is a diagram for explaining network-status information stored in a network-status storage unit in the VoIP gateway apparatus in FIG. 15.

FIG. 17 is a flowchart for explaining a control process performed by the VoIP gateway apparatus in FIG. 15 at the time of call releasing.

FIG. 18 is a flowchart for explaining a control process performed by the VoIP gateway apparatus in FIG. 15 at the time of call setup.

FIG. 19 is a flowchart for explaining a control process performed by the VoIP gateway apparatus in FIG. 15 based on the previously stored network-status information.

FIG. 20 is a diagram for explaining a target value of the packet loss ratio or the packet arrival time jitter

FIG. 21 is a block diagram of another preferred embodiment of the VoIP gateway apparatus of the invention which uses information supplied by a voice data quality estimation unit.

FIG. 22 is a flowchart for explaining a control process performed by the voice data quality estimation unit of the VoIP gateway apparatus in FIG. 21.

FIG. 23 is a flowchart for explaining another control process performed by the voice data quality estimation unit of the VoIP gateway apparatus in FIG. 21.

FIG. 24 is a flowchart for explaining another control process performed by the voice data quality estimation unit of the VoIP gateway apparatus in FIG. 21.

FIG. 25 is a diagram for explaining operation of the voice communication network system in which a plurality of the VoIP gateway apparatuses according to the invention are provided.

### DETAILED DESCRIPTION OF PREFERRED EMBODIMENTS

A description will now be provided of the preferred embodiments of the present invention with reference to the accompanying drawings.

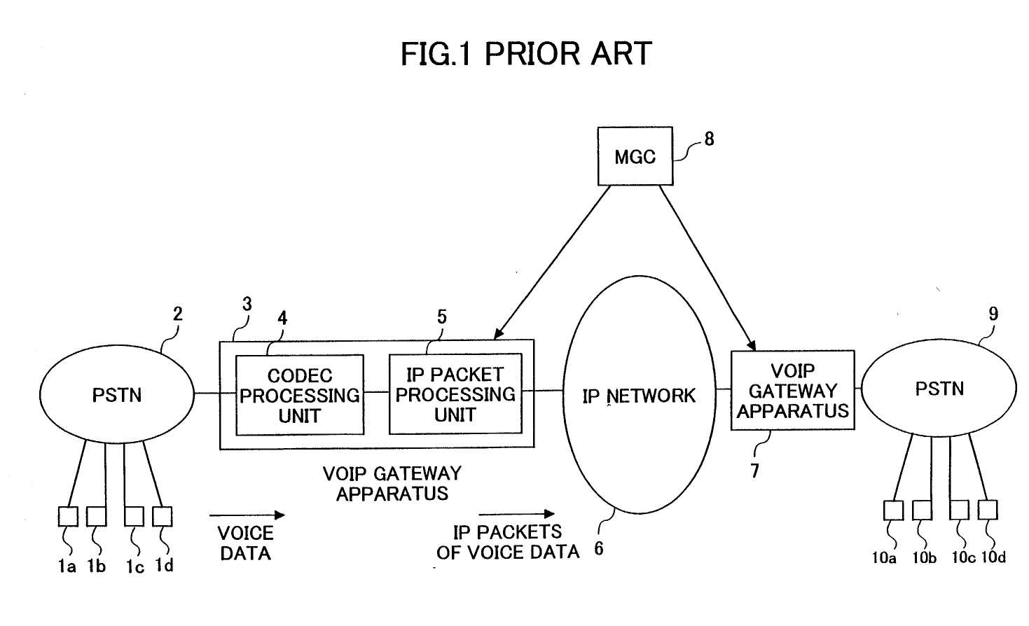

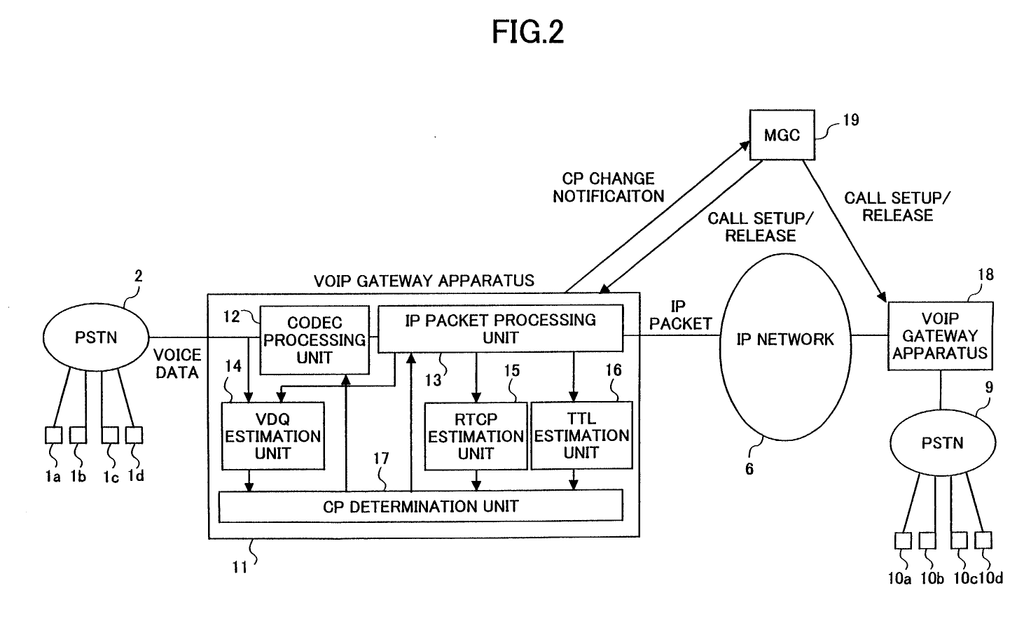

FIG. 2 shows a voice communication network system in which the VoIP gateway apparatus according to the invention is provided. In FIG. 2, the elements that are essentially the same as corresponding elements in FIG. 1 are designated by the same reference numerals, and a description thereof will be omitted.

In the voice communication network system in FIG. 2, voice data, which is sent by any of the subscriber terminals 1a, 1b, 1c and 1d, is transmitted to the VoIP gateway apparatus 11 of the invention via the PSTN 2. The VoIP gateway apparatus 11 generally includes a CODEC processing unit 12, an IP packet processing unit 13, a VDQ (voice data quality) estimation unit 14, a RTCP (real-time transport control protocol) estimation unit 15, a TTL (time to live) estimation unit 16, and a CP (control parameter) determination unit 17.

In the VoIP gateway apparatus 11, the CODEC processing unit 12 receives the voice data from the PSTN 2 and generates encoded voice data from the received voice data. The encoded voice data is sent to the IP packet processing unit 13. The types of the voice data encoding that can be performed by the CODEC processing unit 12 include: ITU-T G.711 μ-Low/A-Low (64 kb/s PCM); G.729a (8 kb/s CS-ACELP); G.723.1 (6.3 kb/s Mp-MLQ); G.723.1 (5.3 kb/s ACELP); G.729 (32 kb/s ADPCM); G.727 (ADPCM); G.727 (E-ADPCM); G.729 Annex B (non-voice compression); and G.723.1 Annex B (non-voice compression). In the present embodiment, one of these types of the voice data encoding is selected based the estimated IP network state, and the encoding of the voice data is performed by the CODEC processing unit 12 according to the selected type.

The IP packet processing unit 13 creates IP packets of the encoded voice data from the CODEC processing unit 12, and transmits the IP packets to another VoIP gateway apparatus 18 via the IP network 6. The VoIP gateway apparatus 11 will be called the sender VoIP gateway apparatus 11, while the VoIP gateway apparatus 18 will be called the receiver VoIP gateway apparatus 18. The receiver VoIP gateway apparatus 18 receives the IP packets from the IP network 6, and creates the decoded voice data from the received IP packets. The receiver VoIP gateway apparatus 18 transmits the decoded voice data to any of the subscriber terminals 10a, 10b, 10c and 10d via the PSTN 9.

In the voice communication network system in FIG. 2, the media gateway controller (MGC) 19 is provided to send control instructions to the VoIP gateway apparatus 11 (or the VoIP gateway apparatus 18) at the time of call setup. In the VoIP gateway apparatus 11, the encoding of the CODEC processing unit 12 and the packetizing of the IP packet processing unit 13 are controlled based on the control instructions received from the MGC 19. For example, the VoIP gateway apparatus 11 determines the encoding type of the voice data encoding by the CODEC processing unit 12, the IP address of the receiver VoIP gateway apparatus 18, the receiver subscriber terminal (one of the of the subscriber terminals 10a, 10b, 10c and 10d) and the UDP-Port (which is used to identify the PSTN subscriber) based on the control instructions received from the MGC 19 at the time of call setup.

In the VoIP gateway apparatus 11, the VDQ estimation unit 14 determines an estimated transmission delay and an estimated voice data quality level based on test voice data that are sent to the receiver VoIP gateway apparatus 18 and test packets that are received from the receiver VoIP gateway apparatus 18. Specifically, the VDQ estimation unit 14 sends the test voice data to the receiver VoIP gateway apparatus 18 through a given network-state-estimation channel of the PSTN 2, and receives the test packets from the receiver VoIP gateway apparatus 18. The VDQ estimation unit 14 determines an estimated transmission delay and an estimated voice data quality level based on the result of comparison of the test voice data and the test packets.

Further, in the VoIP gateway apparatus 11, the RTCP estimation unit 15 reads a packet loss ratio and a packet arrival time jitter (which indicates the packet arrival time fluctuation) from RTCP packets that are periodically received at the sender VoIP gateway apparatus 11 from the receiver VoIP gateway apparatus 18.

Further, in the VoIP gateway apparatus 11, the TTL estimation unit 16 generates a hop count (the number of intermediate routers between the sender VoIP gateway apparatus 11 and the receiver VoIP gateway apparatus 18) by using an IP-TTL value of the packet that is received from the receiver VoIP gateway apparatus 18. Alternatively, the TTL estimation unit 16 may calculate a hop count by using an IP-TTL value of a reply packet received from the receiver VoIP gateway apparatus 18 after an ICMP (Internet control message protocol)-PING request is sent thereto. Alternatively, the TTL estimation unit 16 may calculate a hop count by using the result of a route tracing that is performed for the receiver VoIP gateway apparatus 18.

Further, in the VoIP gateway apparatus 11, the CP determination unit 17 controls the encoding of the CODEC processing unit 12 and the packetizing of the IP packet processing unit 13 by sending the IP-ToS value, the CODEC type, the option of non-voiced data compression/non-compression, and the jitter buffer amount to the processing units 12 and 13 based on the estimated IP network state information received from the VDQ estimation unit 14, the RTCP estimation unit 15 and the TTL estimation unit 16.

According to the VoIP gateway apparatus 11 (or 18) of the present invention, the CP determination unit 17 determines the IP-ToS value, the CODEC type, the option of non-voiced data compression/non-compression, and the jitter buffer amount based on at least one of the estimated IP network state information received from the VDQ estimation unit 14, the estimated IP network state information received from the RTCP estimation unit 15, and the estimated IP network state information received from the TTL estimation unit 16.

A description will now be given of the various methods of determining the IP-ToS value, the CODEC type, the option of non-voiced data compression/non-compression, or the jitter buffer amount based on the network state information received from any of the VDQ estimation unit 14, the RTCP estimation unit 15 and the TTL estimation unit 16.

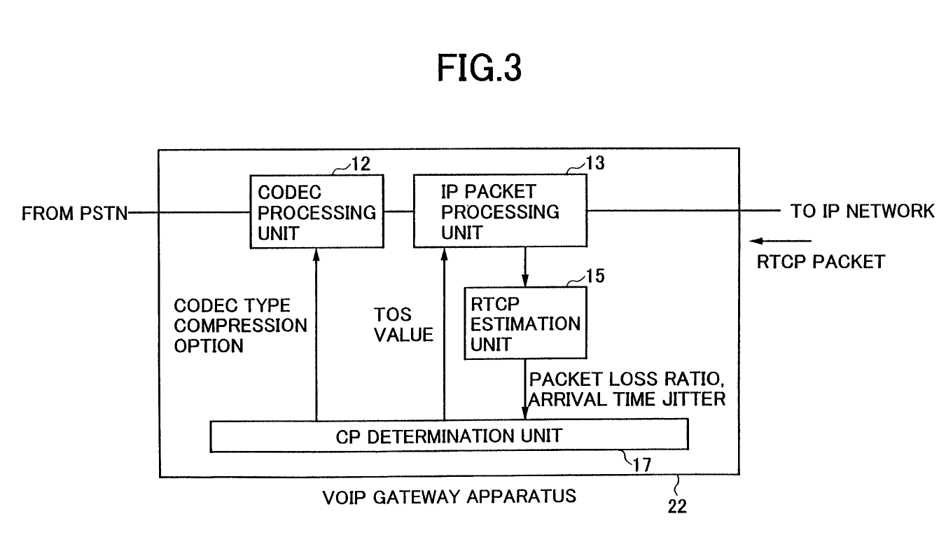

FIG. 3 shows one preferred embodiment of the VoIP gateway apparatus of the invention in the voice communication network system.

In the present embodiment, the VoIP gateway apparatus 22 uses the network-state information received from the RTCP estimation unit 15, in order to determine the IP-ToS value, the CODEC type, the option of non-voiced data compression/non-compression, or the jitter buffer amount.

As shown in FIG. 3, the VoIP gateway apparatus 22 of the present embodiment includes the CODEC processing unit 12, the IP packet processing unit 13, the RTCP estimation unit 15, and the CP determination unit 17.

In the present embodiment, the VoIP gateway apparatus 22 periodically receives the RTCP packets from the receiver VoIP gateway apparatus 18 via the IP network 6. The received RTCP packets are sent from the IP packet processing unit 13 to the RTCP estimation unit 15. The RTCP estimation unit 15 reads a packet loss ratio and a packet arrival time jitter value (which indicates the packet arrival time fluctuation) from the received RTCP packets. The RTCP estimation unit 15 sends the packet loss ratio and the packet arrival time jitter value to the CP determination unit 17.

In the VoIP gateway apparatus 22 of the present embodiment, the CP determination unit 17 determines an IP-ToS (type of service) value based on the received packet loss ratio and the received packet arrival time jitter value. The CP determination unit 17 transmits the IP-ToS value to the IP packet processing unit 13 so that the packetizing of the IP packet processing unit 13 is controlled. Further, the CP determination unit 17 determines the CODEC type and the non-voiced data compression/non-compression option based on the received packet loss ratio and the received packet arrival time jitter value. The CP determination unit 17 transmits the CODEC type and the compression option to the CODEC processing unit 12 so that the encoding of the CODEC processing unit 12 is controlled.

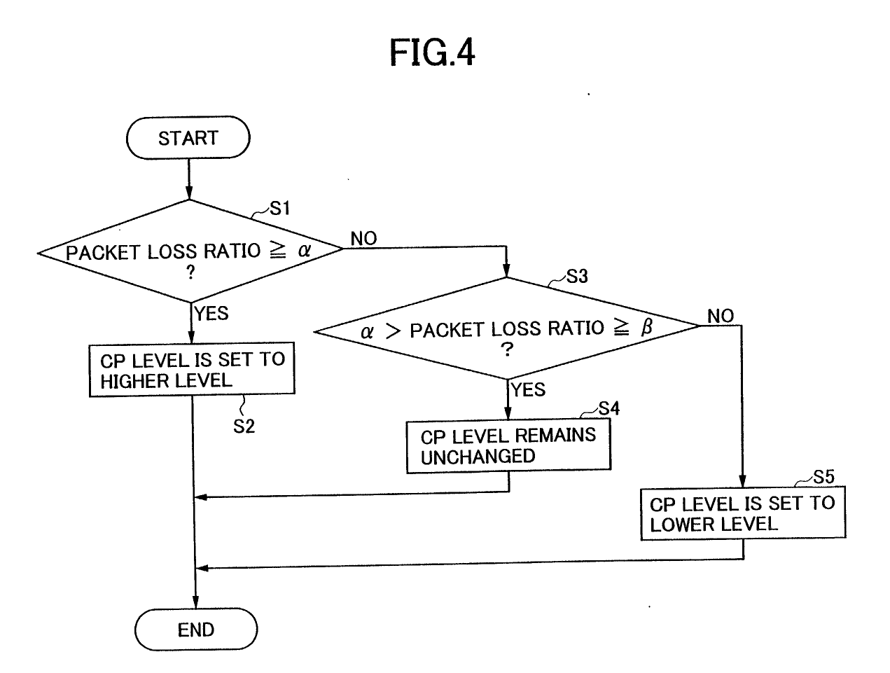

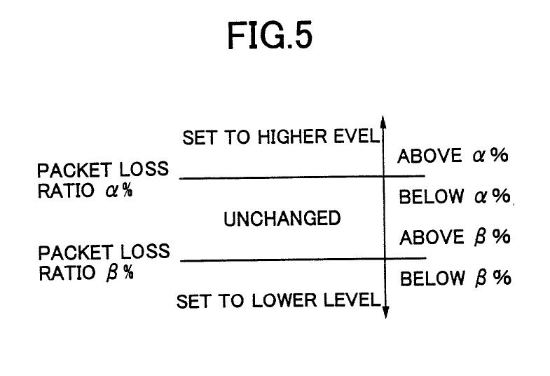

FIG. 4 shows a control process performed by the CP determination unit 17 of the VoIP gateway apparatus in FIG. 3 based on the estimated packet loss ratio of the IP network. FIG. 5 is a diagram for explaining a target value of the packet loss ratio.

In the present embodiment, the upper-limit value (α) and the lower-limit value (β) of the packet loss ratio, shown in FIG. 5 are stored into the CP determination unit 17. In other words, the target value of the packet loss ratio used by the CP determination unit 17 in controlling the voice data quality is larger than the lower-limit value β and smaller than the upper-limit value α.

As shown in FIG. 4, at a start of the control process, the determination unit 17 at step S1 determines whether the received packet loss ratio (which is received from the RTCP estimation unit 15) is above the upper-limit value α. When the result at the step S1 is affirmative (packet loss ratio>α), the determination unit 17 at step S2 determines that the current control parameter (CP) level does not reach the desired level, and sets the CP level to the higher level (which is incremented from the current CP level).

On the other hand, when the result at the step S1 is negative, the determination unit 17 at step S3 determines whether the received packet loss ratio is above the lower-limit value β and below the upper-limit value α. When the result at the step S3 is affirmative (β<packet loss ratio<α), the determination unit 17 at step S4 determines that the current CP level does reach the desired level, and the current CP level remains unchanged. On the other hand, when the result at the step S3 is negative (packet loss ratio<β), the determination unit 17 at step S5 determines that the current CP level exceeds the desired level, and sets the CP level to the lower level (which is decremented from the current CP level). After one of the steps S2, S4 and S5 is performed, the control process of FIG. 4 ends.

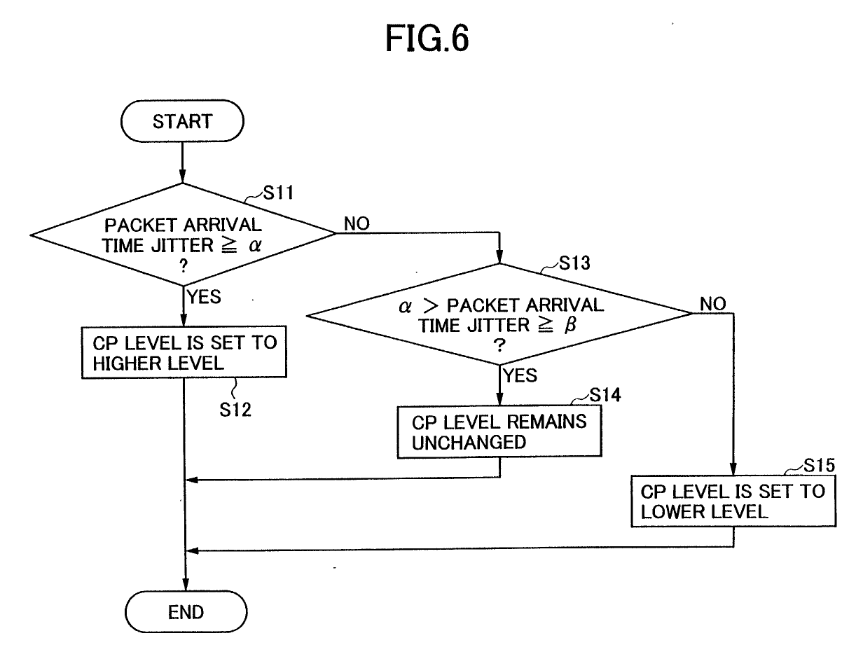

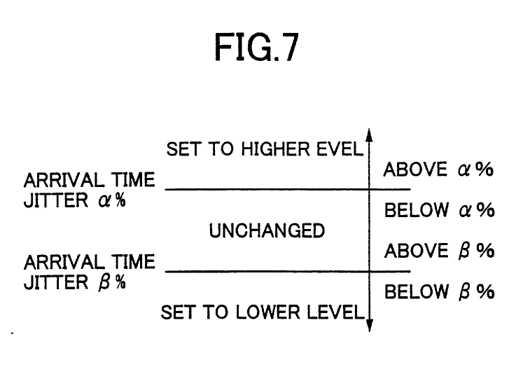

FIG. 6 shows another control process performed by the determination unit 17 of the VoIP gateway apparatus in FIG. 3 based on the estimated packet arrival time jitter of the IP network. FIG. 7 is a diagram for explaining a target value of the packet arrival time jitter.

In the present embodiment, the upper-limit value (α) and the lower-limit value (β) of the packet arrival time jitter, shown in FIG. 7, are stored into the CP determination unit 17. In other words, the target value of the packet arrival time jitter used by the CP determination unit 17 in controlling the voice data quality is larger than the lower-limit value β and smaller than the upper-limit value α.

As shown in FIG. 6, at a start of the control process, the determination unit 17 at step S11 determines whether the received packet arrival time jitter (which is received from the RTCP estimation unit 15) is above the upper-limit value α. When the result at the step S11 is affirmative (packet arrival time jitter>α), the determination unit 17 at step S12 determines that the current control parameter (CP) level does not reach the desired level, and sets the CP level to the higher level (which is incremented from the current CP level).

On the other hand, when the result at the step S11 is negative, the determination unit 17 at step S13 determines whether the received packet arrival time jitter is above the lower-limit value β and below the upper-limit value α. When the result at the step S13 is affirmative (β<packet arrival time jitter<α), the determination unit 17 at step S14 determines that the current CP level does reach the desired level, and the current CP level remains unchanged. On the other hand, when the result at the step S13 is negative (packet arrival time jitter<β), the determination unit 17 at step S15 determines that the current CP level exceeds the desired level, and sets the CP level to the lower level (which is lowered from the current CP level by one level). After one of the steps S12, S14 and S15 is performed, the control process of FIG. 6 ends.

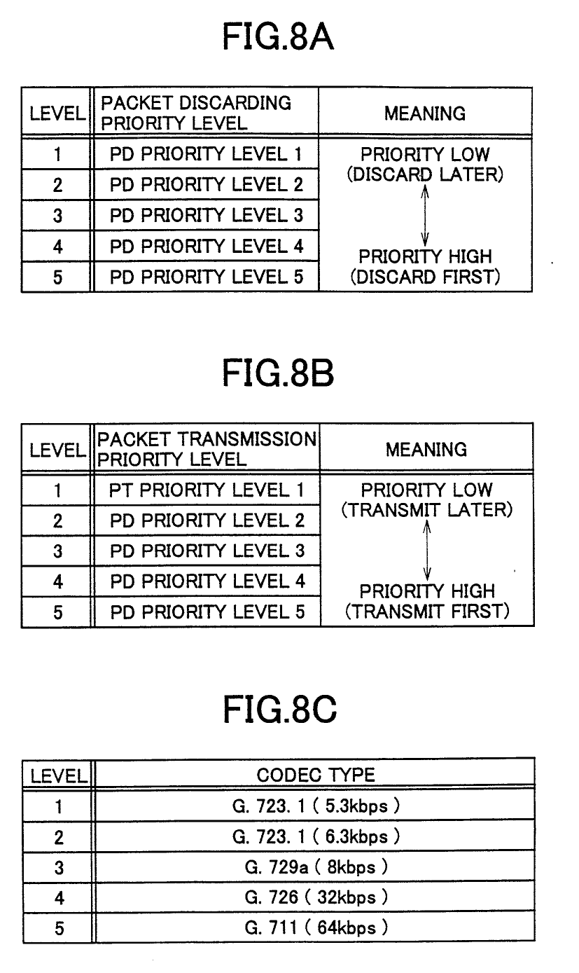

FIG. 8A, FIG. 8B and FIG. 8C are diagrams for explaining the control parameters (CP) including a packet discarding priority level, a packet transmission priority level and a CODEC type level.

As described above, the determination unit 17 determines a specific one of the plurality of the CP levels based on the network state information received from the RTCP estimation unit 15. FIG. 8A shows a set of the packet discarding priority levels one of which is selected based on the IP-ToS value, FIG. 8B shows a set of the packet transmission priority levels one of which is selected based on the IP-ToS value, and FIG. 8C shows a set of the CODEC type levels one of which is selected based on the received network state information.

In the case of the packet discarding priority levels in FIG. 8A, when the packet discarding priority level is set to the higher level (the level number is incremented), the priority of packet discarding becomes high. In the case of the packet transmission priority levels in FIG. 8B, when the packet transmission priority level is set to the higher level (the level number is incremented), the priority of packet transmission becomes high. In the case of the CODEC types in FIG. 8C, the CODEC type level-1 is G.723.1 (5.3 kbps), the CODEC type level-2 is G.723.1 (6.3 kbps), the CODEC type level-3 is G.729a (8 kbps), the CODEC type level-4 is G.726 (32 kbps), and the CODEC type level-5 is G.711 (64 kbps). When the CODEC type level is set to the lower level (the level number is decremented), the packet loss ratio and the packet arrival time jitter improve.

Suppose that the current CP levels are set to the discarding priority level-5, the transmission priority level-1, the CODEC type level-5 (G.711, 64 kbps), and the non-voiced data non-compression option. If each CP level is set to the higher level through the execution of the control process in FIG. 4 or FIG. 6, the packet discarding priority level is set to the level-4, the packet transmission priority level is set to the level-2, the CODEC type level is set to the level-4 (G.726, 32 kbps), and the non-voiced data compression option is set.

In the present embodiment, it is not necessary for the determination unit 17 to determine one of the CP levels for all of the current control parameters (CP) including the packet discarding priority level, the packet transmission priority level, the CODEC type level and the non-voiced data compression/non-compression option. The determination unit 17 may determine one of the CP levels with respect to arbitrary ones of the current control parameters.

In the VoIP gateway apparatus 11 in FIG. 2, when the control parameters (CP) to the CODEC processing unit 12 and the IP packet processing unit 13 are changed, the VoIP gateway apparatus 11 transmits a notice of the control parameter (CP) changes to the receiver VoIP gateway apparatus 18 via the MGC 19. When the CODEC type level is changed, the VoIP gateway apparatus 11 transmits a notice of the CODEC type level change to the receiver VoIP gateway apparatus 18 via the MGC 19. Alternatively, in such a case, the VoIP gateway apparatus 11 may transmit a notice of the CODEC type level change to the receiver VoIP gateway apparatus 18 via the IP network 6, by including the above notice in the payload type of the RTP header of the voice packet.

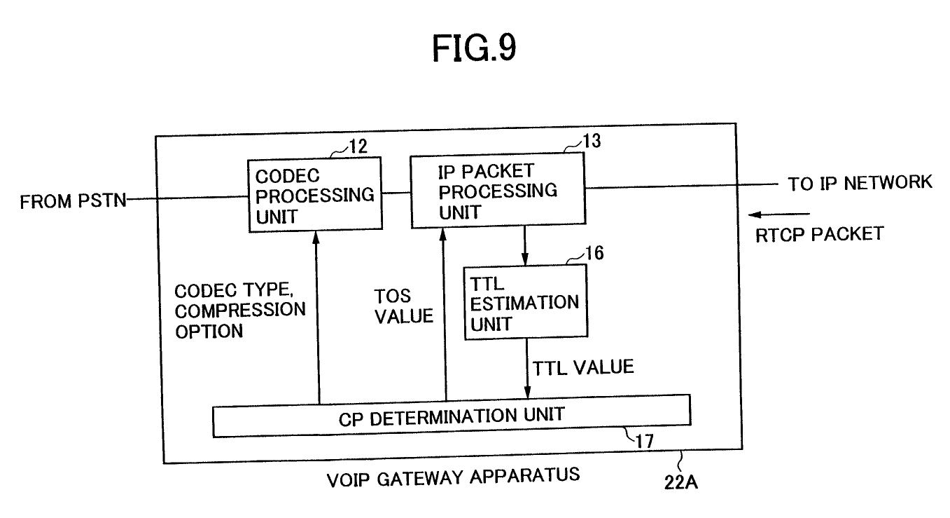

Next, FIG. 9 shows another preferred embodiment of the VoIP gateway apparatus of the invention.

In the present embodiment, the VoIP gateway apparatus 22A uses the network-state information received from the TTL estimation unit 16, in order to determine one of the control parameter levels (the hop count), which will be described later.

As shown in FIG. 9, the VoIP gateway apparatus 22A of the present embodiment includes the CODEC processing unit 12, the IP packet processing unit 13, the TTL estimation unit 16, and the CP determination unit 17. Similar to the previous embodiment of FIG. 2, the VoIP gateway apparatus 22A is connected to each of the PSTN 2, the IP network 6 and the MGC 19 but the illustration of these elements is omitted in the present embodiment of FIG. 9 for the sake of convenience.

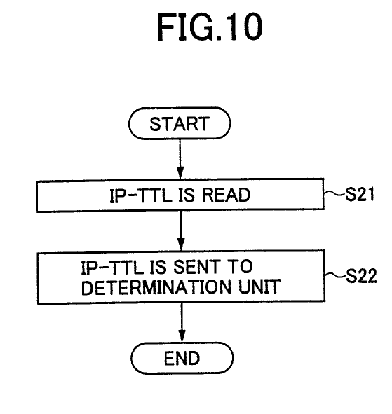

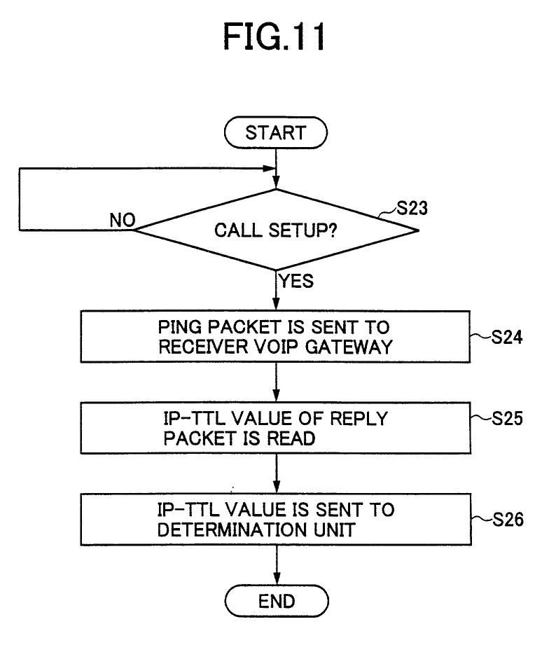

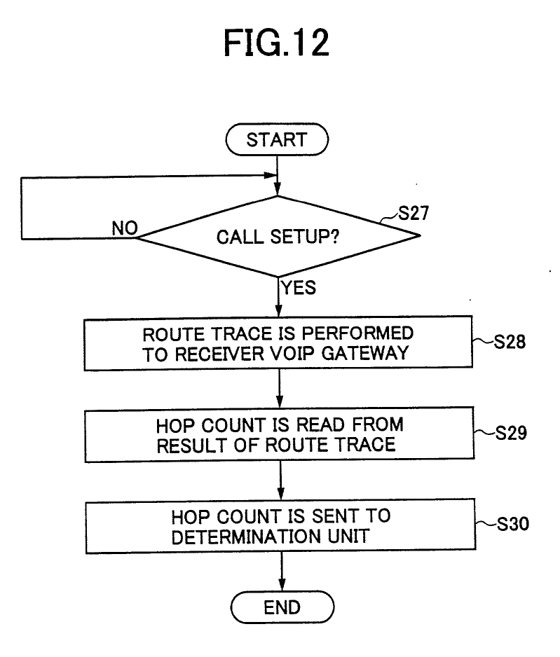

FIG. 10 shows a reading process performed by the TTL estimation unit 16 of the VoIP gateway apparatus 22A. FIG. 11 shows another reading process performed by the TTL estimation unit 16 of the VoIP gateway apparatus 22A. FIG. 12 shows another reading process performed by the TTL estimation unit 16 of the VoIP gateway apparatus 22A.

In the present embodiment, the TTL estimation unit 16 reads, as shown in FIG. 10, an IP-TTL value from a voice packet which is received from the receiver VoIP gateway apparatus 18 via the IP network 6 immediately after the start of communication. The TTL estimation unit 16 sends the IP-TTL value to the CP determination unit 17.

As shown in FIG. 10, at a start of the reading process, the TTL estimation unit 16 at step S21 reads an IP-TTL value from a voice packet which is received from the receiver VoIP gateway apparatus 18 via the IP network 6 immediately after the start of communication. After the step S21 is performed, the TTL estimation unit 16 at step S22 sends the IP-TTL value (or a hop count derived from the IP-TTL value) to the CP determination unit 17. After the step S22 is performed, the reading process of FIG. 10 ends.

Alternatively, as shown in FIG. 11, the TTL estimation unit 16 reads an IP-TTL value of a reply packet which is received from the receiver VoIP gateway apparatus 18 after the ICMP-PING request is sent thereto immediately before the time of call setup or at the time of call setup. The TTL estimation unit 16 sends the IP-TTL value to the CP determination unit 17.

As shown in FIG. 11, at a start of the reading process, the TTL estimation unit 16 at step S23 determines whether the VoIP gateway apparatus 22A is set in the condition of call setup. When the result at the step S23 is affirmative (the condition of call setup), the TTL estimation unit 16 performs the next step S24. Otherwise the control of the TTL estimation unit 16 is repeatedly transferred to the step S23.

The TTL estimation unit 16 at step S24 causes the VoIP gateway apparatus 22A to transmit a PING request packet to the receiver VoIP gateway apparatus 18 via the IP network 6, and to receive a reply packet from the receiver VoIP gateway apparatus 18. After the step S24 is performed, the TTL estimation unit 16 at step S25 reads an IP-TTL value from the received reply packet. After the step S25 is performed, the TTL estimation unit 16 at step S26 sends the IP-TTL value (or a hop count derived from the IP-TTL value) to the CP determination unit 17. After the step S26 is performed, the reading process of FIG. 11 ends.

Alternatively, as shown in FIG. 12, the TTL estimation unit 16 calculates a hop count by using the result of a route tracing that is performed for the receiver VoIP gateway apparatus 18. The TTL estimation unit 16 sends the hop count to the CP determination unit 17. For example, the hop count is calculated from the IP-TTL value in accordance with the equation: hop count=(IP-TTL maximum value)−(IP-TTL value).

As shown in FIG. 12, at a start of the reading process, the TTL estimation unit 16 at step S27 determines whether the VoIP gateway apparatus 22A is set in the condition of call setup. When the result at the step S27 is affirmative (the condition of call setup), the TTL estimation unit 16 performs the next step S28. Otherwise the control of the TTL estimation unit 16 is repeatedly transferred to the step S27.

The TTL estimation unit 16 at step S28 causes the VoIP gateway apparatus 22A to perform a route trace for the receiver VoIP gateway apparatus 18, and to receive the result of the route trace from the receiver VoIP gateway apparatus 18. After the step S28 is performed, the TTL estimation unit 16 at step S29 reads a hop count of the intermediate routers from the result of the route trace. After the step S29 is performed, the TTL estimation unit 16 at step S30 sends the hop count to the CP determination unit 17. After the step S30 is performed, the reading process of FIG. 12 ends.

In the VoIP gateway apparatus 22A of the present embodiment, when the hop count is received at the determination unit 17, the determination unit 17 determines an IP-ToS value based on the received hop count. The determination unit 17 transmits the IP-ToS value to the IP packet processing unit 13 so that the packetizing of the IP packet processing unit 13 is controlled. Further, the determination unit 17 determines the CODEC type and the non-voiced data compression/non-compression option based on the received hop count. The determination unit 17 transmits the CODEC type and the compression option to the CODEC processing unit 12 so that the encoding of the CODEC processing unit 12 is controlled.

In the present embodiment, the relationship between the hop counts and the control parameter levels (the IP-ToS values, the CODEC type levels and the compression option) is predetermined, and it is stored into the CP determination unit 17. Thus, the CP determination unit 17 can determine the CP level based on the received hop count. Generally, when the received hop count is large, the number of the intermediate routers in the IP network is large. In such a case, it is required that the CP level is set to the higher level. On the other hand, when the received hop count is small, the number of the intermediate routers is small. In such a case, it is sufficient that the CP level is set to the lower level.

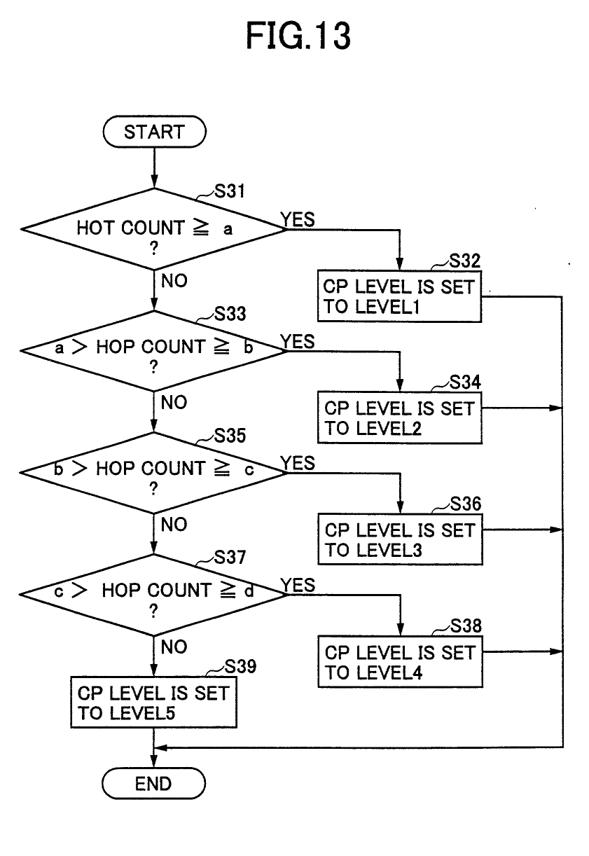

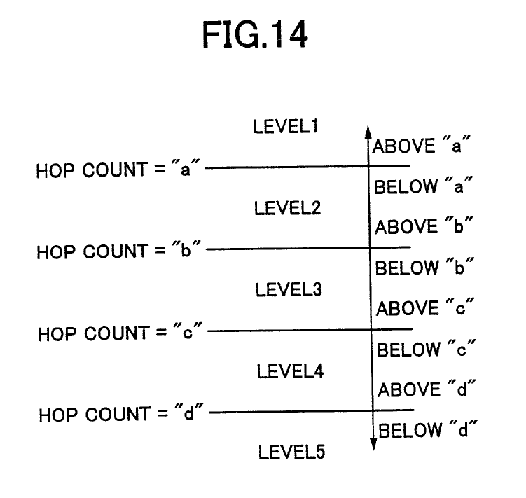

FIG. 13 shows a control process performed by the CP determination unit 17 of the VoIP gateway apparatus 22A. FIG. 14 is a diagram for explaining a target value of the hop count.

In the present embodiment, the determination unit 17 determines the IP-ToS value, the CODEC type level, the compression/non-compression option or the jitter buffer amount based on the received hop count.

In the present embodiment, as shown in FIG. 14, a set of reference hop counts “a”, “b”, “c” and “d” (a>b>c>d) and corresponding CP levels “LEVEL1”, “LEVEL2”, “LEVEL3”, “LEVEL4” and “LEVEL5” are predetermined as the threshold values, and such correspondence is stored into the determination unit 17. Namely, the relationship between the hop counts and the control parameter levels is predetermined, and it is stored into the determination unit 17.

In the present embodiment, when the hop count is received from the TTL estimation unit 16, the CP determination unit 17 determines a CP level based on the received hop count. The CP determination unit 17 transmits the CP level to the CODEC processing unit 12 or the IP packet processing unit 13 so as to control the encoding of the CODEC processing unit 12 or the packetizing of the IP packet processing unit 13.

As shown in FIG. 13, at a start of the control process, the determination unit 17 at step S31 determines whether the received hop count (which is received from the TTL estimation unit 16) is above the reference hop count “a”. When the result at the step S31 is affirmative (received hop count ≧a), the determination unit 17 at step S32 sets the CP level to the LEVEL1.

When the result at the step S31 is negative, the determination unit 17 at step S33 determines whether the received hop count is above the reference hop count “b” and below the reference hop count “a”. When the result at the step S33 is affirmative (b≦received hop count<a), the determination unit 17 at step S34 sets the CP level to the LEVEL2.

On the other hand, when the result at the step S33 is negative, the determination unit 17 at step S35 determines whether the received hop count is above the reference hop count “c” and below the reference hop count “b”. When the result at the step S35 is affirmative (c≦received hop count<b), the determination unit 17 at step S36 sets the CP level to the LEVEL3.

When the result at the step S35 is negative, the determination unit 17 at step S37 determines whether the received hop count is above the reference hop count “d” and below the reference hop count “c”. When the result at the step S37 is affirmative (d≦received hop count<c), the determination unit 17 at step S38 sets the CP level to the LEVEL4. Otherwise, the determination unit 17 at step S39 sets the CP level to the LEVEL5. After one of the steps S32, S34, S36, S38 and S39 is performed, the control process of FIG. 13 ends.

The control parameter (CP) levels, which are used in the control process of FIG. 13 in the present embodiment, may be determined in the same manner as the packet discarding priority levels, the packet transmission priority levels control parameter levels and the CODEC type levels of FIG. 8A, FIG. 8B and FIG. 8C in the previous embodiment. Further, the non-voiced data compression/non-compression option may be determined depending on whether the CP level is higher than the LEVEL3 or not.

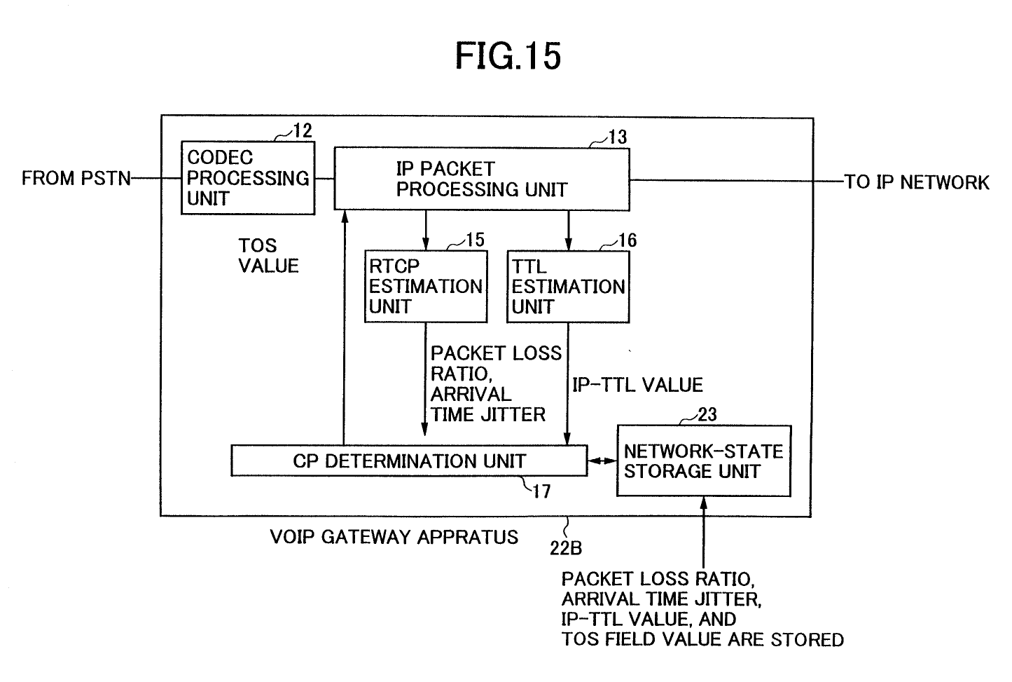

Next, FIG. 15 shows another preferred embodiment of the VoIP gateway apparatus of the invention.

In the present embodiment, the VoIP gateway apparatus 22B uses the network-state information stored in a network-state storage unit 23, in order to determine one of the control parameter levels, which will be described later.

As shown in FIG. 15, the VoIP gateway apparatus 22B of the present embodiment includes the CODEC processing unit 12, the IP packet processing unit 13, the TTL estimation unit 15, the RTCP estimation unit 16, the CP determination unit 17, and the network-state storage unit 23. The network-state information with respect to each of respective destination stations (e.g., the receiver VoIP gateway apparatuses) is stored into the network-state storage unit 23. Similar to the previous embodiment of FIG. 2, the VoIP gateway apparatus 22B is connected to each of the PSTN 2, the IP network 6 and the MGC 19 but the illustration of these elements is omitted in the present embodiment of FIG. 15 for the sake of convenience.

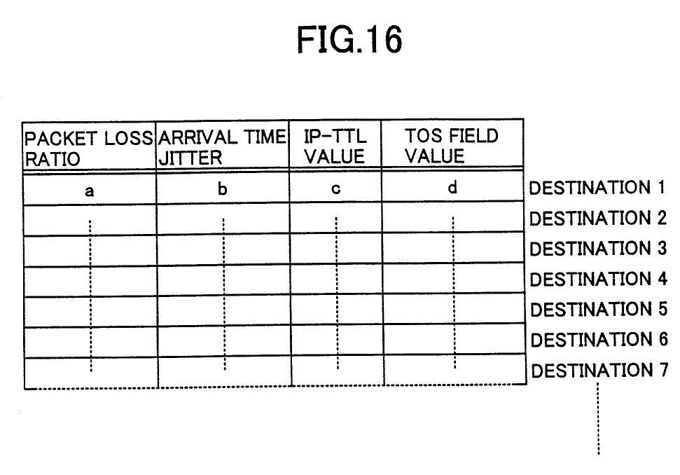

FIG. 16 shows the network status information stored in the network-status storage unit 23. As shown in FIG. 16, in the VoIP gateway apparatus 22B of the present embodiment, the network-state storage unit 23 stores the network-state information, containing the packet loss ratio “a”, the packet arrival time jitter “b”, the IP-TTL value “c” and the ToS field value “d” with respect to each destination. These network-state information items are stored into the storage unit 23 at the time of a previous communication between the VoIP gateway apparatus 22B and a corresponding one of the respective destination stations (DESTINATION1, DESTINATION2, etc.).

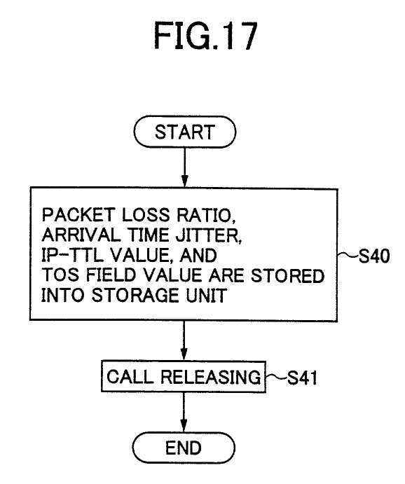

FIG. 17 shows a control process performed by the VoIP gateway apparatus 22B at the time of call releasing. As shown, in the VoIP gateway apparatus 22B of the present embodiment, the network-state information items (the packet loss ratio, the packet arrival time jitter, the IP-TTL value and the ToS field value) with respect to each of the respective destination stations are stored into the storage unit 23 prior to the time of call releasing (the end of communication).

More specifically, the determination unit 17 starts execution of the control process in FIG. 17 prior to the time of call releasing (the end of communication). At the start of the control process in FIG. 17, the determination unit 17 at step S40 causes the network state storage unit 23 to store the packet loss ratio, the packet arrival time jitter, the IP-TTL value and the ToS field value of each of the respective destination stations. After the step S40 is performed, the determination unit 17 at step S41 performs the call releasing process. After the step S41 is performed, the control process of FIG. 17 ends.

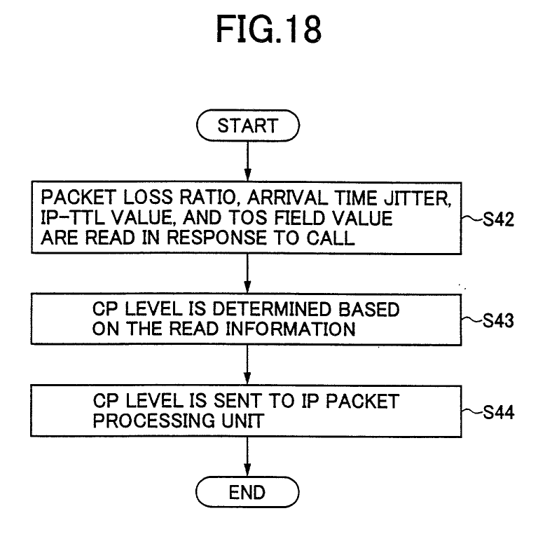

FIG. 18 shows a control process performed by the VoIP gateway apparatus 22B at the time of call setup. As shown, in the VoIP gateway apparatus 22B of the present embodiment, the network-state information items (the packet loss ratio, the packet arrival time jitter, the IP-TTL value and the ToS field value) with respect to each of the respective destination stations, previously stored in the network-state storage unit 23, are transmitted to the determination unit 17 at the time of call setup (the start of communication).

More specifically, the determination unit 17 starts execution of the control process in FIG. 18 at the time of call setup. At the start of the control process in FIG. 18, the determination unit 17 at step S42 reads, from the network-state storage unit 23, the previously stored network-state information items, which includes the packet loss ratio, the packet arrival time jitter, the IP-TTL value and the ToS field value with respect to one of the destination stations corresponding to the called station.

After the step S42 is performed, the determination unit 17 at step S43 determines an IP-ToS value (or the control parameter (CP) level) based on the previously stored information items (the packet loss ratio, the packet arrival time jitter, the IP-TTL value and the ToS field value) read from the network-state storage unit 23. After the step S43 is performed, the determination unit 17 at step S44 sends the IP-ToS value (the CP level) to the IP packet processing unit 13, so that the packetizing of the IP packet processing unit 13 is controlled. After the step S44 is performed, the control process of FIG. 18 ends.

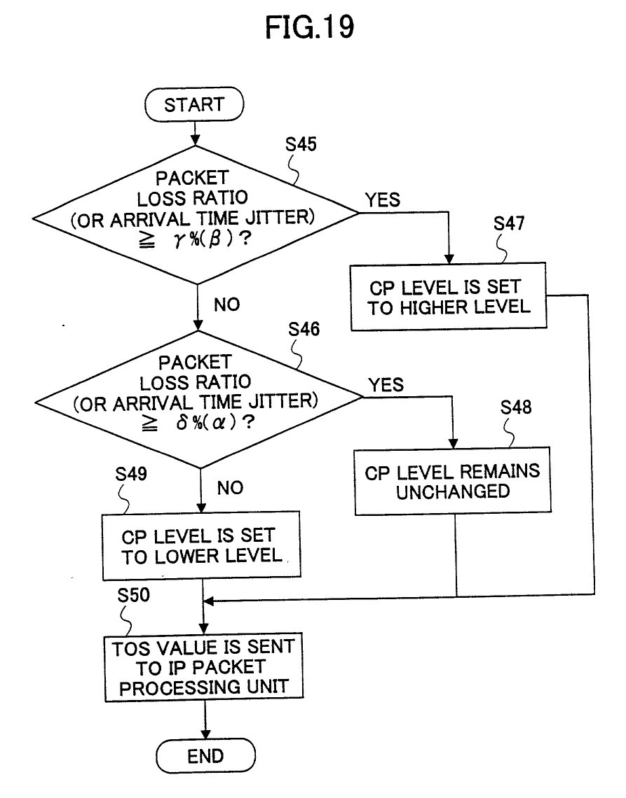

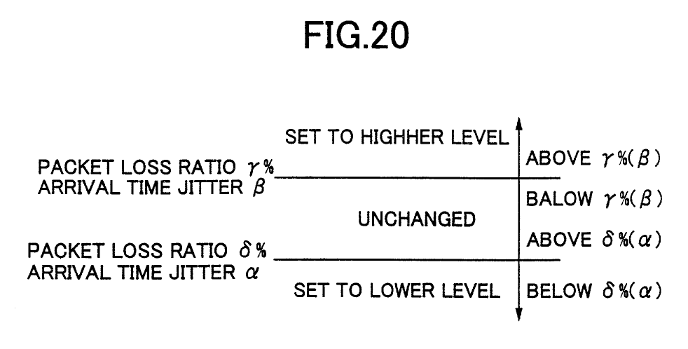

FIG. 19 shows a control process performed by the determination unit 17 of the VoIP gateway apparatus 22B based on the previously stored network-status information. FIG. 20 is a diagram for explaining a target value of the packet loss ratio or the packet arrival time jitter.

In the present embodiment, the upper-limit value (γ) and the lower-limit value (δ) of the packet loss ratio and the upper-limit value (β) and the lower-limit value (α) of the packet arrival time jitter, shown in FIG. 20, are stored into the determination unit 17. In other words, the target value of the packet loss ratio used by the determination unit 17 in controlling the voice data quality is larger than the lower-limit value δ and smaller than the upper-limit value γ. Further, the target value of the packet arrival time jitter used by the determination unit 17 in controlling the voice data quality is larger than the lower-limit value α and smaller than the upper-limit value β.

The determination unit 17 starts the execution of the control process in FIG. 19 when a call connection between the VoIP gateway apparatus 22B and one of the destination stations is established. At a start of the control process, the determination unit 17 at step S45 determines whether the previously stored packet loss ratio (or the previously stored packet arrival time jitter) of the related one of the destination stations, received from the network-state storage unit 23, is above the upper-limit value γ(or β). When the result at the step S45 is affirmative (packet loss ratio≧γ or packet arrival time jitter≧β), the determination unit 17 at step S47 determines that the current CP level does not reach the desired level, and sets the CP level (e.g., the ToS transmission priority level or the ToS discarding priority level, as shown in FIGS. 8A-8C) to the higher level (which is incremented from the current CP level).

On the other hand, when the result at the step S45 is negative, the determination unit 17 at step S46 determines whether the previously stored packet loss ratio (or the previously stored packet arrival time jitter) of the related destination state is above the lower-limit value δ(or α). When the result at the step S46 is affirmative (δ≦packet loss ratio or α≦packet arrival time jitter), the determination unit 17 at step S48 determines that the current CP level does reach the desired level, and the current CP level remains unchanged.

When the result at the step S46 is negative (packet loss ratio <δ or packet arrival time jitter<α), the determination unit 17 at step S49 determines that the current CP level exceeds the desired level, and sets the CP level (the ToS transmission priority level or the ToS discarding priority level) to the lower level (which is decremented from the current CP level).

After one of the steps S47, S48 and S49 is performed, the determination unit 17 at step S50 sends the IP-ToS value to the IP packet processing unit 13, so that the packetizing of the IP packet processing unit 13 is controlled. After the step S50 is performed, the control process of FIG. 19 ends.

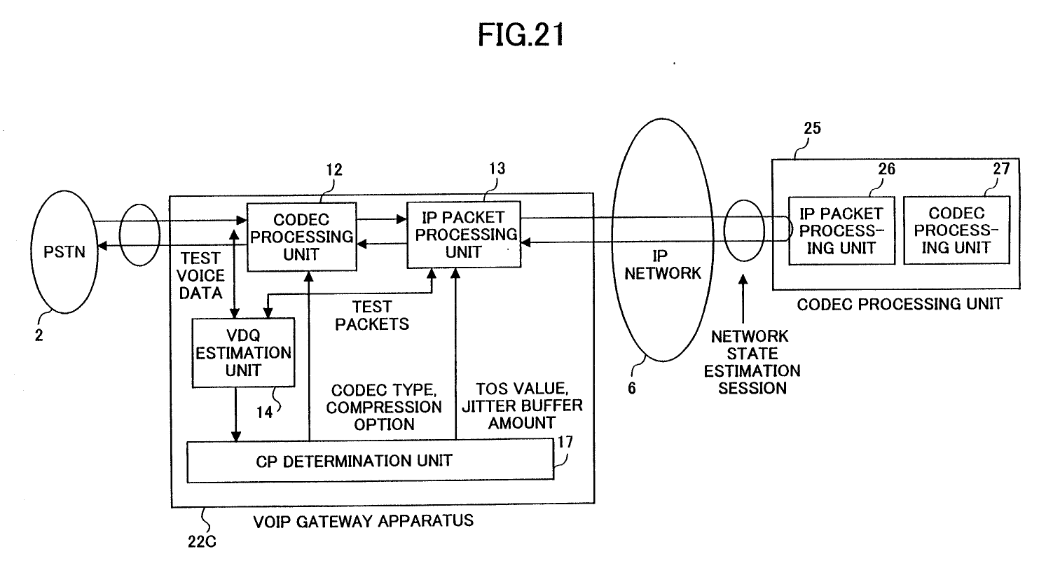

Next, FIG. 21 shows another preferred embodiment of the VoIP gateway apparatus of the invention.

In the present embodiment, the VoIP gateway apparatus 22C uses the voice data quality information supplied by the voice data quality (VDQ) estimation unit 14, in order to determine one of the CP levels, which will be described later.

As shown in FIG. 21, the VoIP gateway apparatus 22C of the present embodiment includes the CODEC processing unit 12, the IP packet processing unit 13, the VDQ estimation unit 14, and the CP determination unit 17. In the voice communication network system in FIG. 21, a plurality of destination stations, including a receiver VoIP gateway apparatus 25, are connected to the IP network 6, and a dedicated voice quality estimation channel (which is called the VQE channel) is provided between the sender VoIP gateway apparatus 22C and the receiver VoIP gateway apparatus 25. The receiver VoIP gateway apparatus 25 includes an IP packet processing unit 26 and a CODEC processing unit 27.

In the voice communication network system in FIG. 21, test voice data is periodically or invariably transmitted to the receiver VoIP gateway apparatus 25 through the VQE channel, and test packets are received from the receiver VoIP gateway apparatus 25, in return, through the VQE channel. In the VoIP gateway apparatus 25, a given UDP-port is allocated to the voice quality estimation UDP-port.

In the VoIP gateway apparatus 22C of the present embodiment, the VDQ estimation unit 14 transmits test voice data to the receiver VoIP gateway apparatus 25 via the IP network 6, and receives test packets from the receiver VoIP gateway apparatus 25 via the IP network 6. In the present embodiment, the CODEC processing unit 12 receives the test voice data from the VDQ estimation unit 14 and generates pulse-code-modulation (PCM) encoded voice data from the received voice data. The IP packet processing unit 13 generates test packets of the PCM encoded test voice data and transmits the test packets to the receiver VoIP gateway apparatus 25 via the IP network 6. Further, the IP packet processing unit 13 receives, in return, the test packets from the receiver VoIP gateway apparatus 25 via the IP network 6, and sends the received test packets to the VDQ estimation unit 14.

In the present embodiment, the VDQ estimation unit 14 determines the network-state information, including an estimated network delay and an estimated voice data quality level, based on the result of comparison of the test voice data and the test packets, which will be described in greater detail below.

In the present embodiment, the selection of the destination station to which the test voice data is transmitted (or the receiver VoIP gateway apparatus 25) from among the plural destination stations in the IP network is performed by using either a simple rotational selection method or a predetermined selection scheme based on the communication frequency or the voice data quality estimation result.

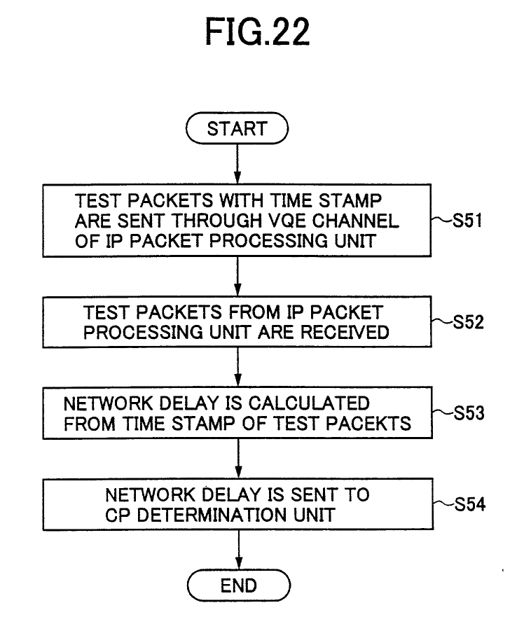

FIG. 22 shows a control process performed by the VDQ estimation unit 14 of the VoIP gateway apparatus 22C.

As shown in FIG. 22, the VDQ estimation unit 14 at step S51 sends test packets with a time stamp to the receiver VoIP gateway apparatus 25 via a given VQE channel of the IP network 6. In response, the receiver VoIP gateway apparatus 25 sends the test packets back to the IP packet processing unit 13 of the VoIP gateway apparatus 22C via the VQE channel of the IP network 6.

After the step S51 is performed, the VDQ estimation unit 14 at step S52 receives the test packets from the IP packet processing unit 13. After the step S52 is performed, the VDQ estimation unit 14 at step S53 calculates a network delay based on the result of comparison of a transmission time of the transmitted test packets and a receiving time of the received test packets. After the step S53 is performed, the VDQ estimation unit 14 at step S54 sends the calculated network delay to the CP determination unit 17. After the step S54 is performed, the control process of FIG. 22 ends.

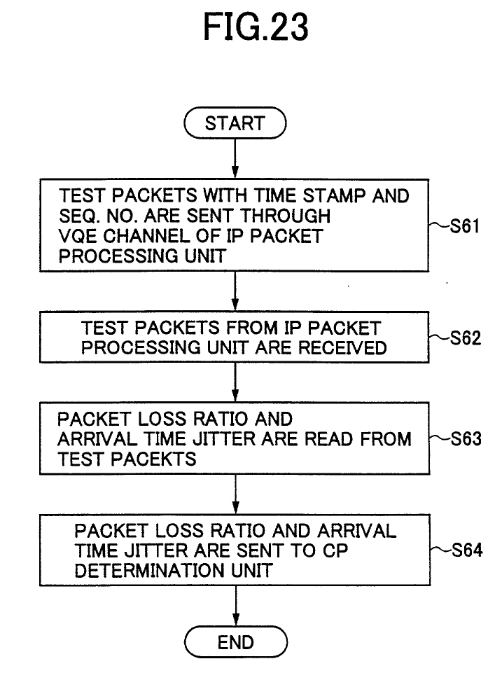

FIG. 23 shows another control process performed by the VDQ estimation unit 14 of the VoIP gateway apparatus 22C.

As shown in FIG. 23, the VDQ estimation unit 14 at step S61 sends test packets with a time stamp and sequential number to the receiver VoIP gateway apparatus 25 via a given VQE channel of the IP network 6. In response, the receiver VoIP gateway apparatus 25 sends the test packets back to the IP packet processing unit 13 of the VoIP gateway apparatus 22C via the VQE channel of the IP network 6.

After the step S61 is performed, the VDQ estimation unit 14 at step S62 receives the test packets from the IP packet processing unit 13. After the step S62 is performed, the VDQ estimation unit 14 at step S63 calculates a packet arrival time jitter and a packet loss ratio based on the result of comparison of a transmission time of the transmitted test packets and a receiving time of the received test packets and based on the result of comparison of the number of the transmitted test packets and the number of the received test packets. After the step S63 is performed, the VDQ estimation unit 14 at step S64 sends the calculated packet arrival time jitter and the calculated packet loss ratio to the CP determination unit 17. After the step S64 is performed, the control process of FIG. 23 ends.

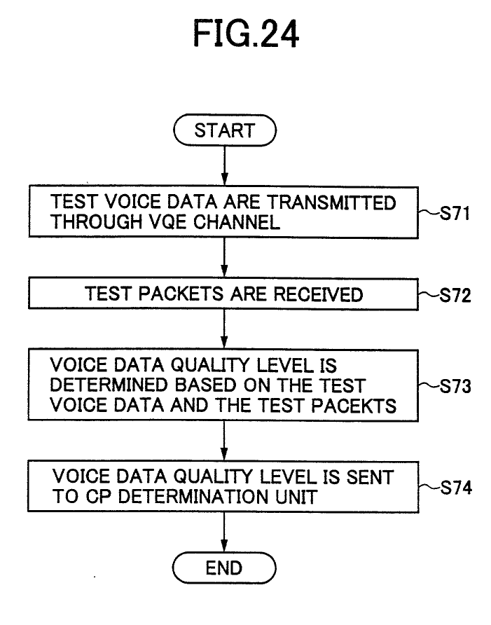

FIG. 24 shows another control process performed by the VDQ estimation unit 14 of the VoIP gateway apparatus 22C.

As shown in FIG. 24, the VDQ estimation unit 14 at step S71 sends test voice data to the CODEC processing unit 12 via a given VQE channel. The CODEC processing unit 12 generates the PCM encoded data from the test voice data, and the IP packet processing unit 13 transmits test packets of the PCM encoded data to the receiver VoIP gateway apparatus 25 via the IP network 6. In response, the receiver VoIP gateway apparatus 25 sends the test packets back to the IP packet processing unit 13 of the VoIP gateway apparatus 22C via the VQE channel of the IP network 6.

After the step S71 is performed, the VDQ estimation unit 14 at step S72 receives the test packets of the PCM encoded data from the IP packet processing unit 13. After the step S72 is performed, the VDQ estimation unit 14 at step S73 calculates a voice data quality level based on the result of comparison of the PCM encoded data of the transmitted test packets and the PCM encoded data of the received test packets. The calculation of a voice data quality level may be performed by using, for example, the PSQM according to ITU-T P861. After the step S73 is performed, the VDQ estimation unit 14 at step S74 sends the calculated voice data quality level to the CP determination unit 17. After the step S74 is performed, the control process of FIG. 24 ends.

Accordingly, if the VoIP gateway apparatus of the present invention is utilized for the voice communication network system, it will make it possible that the voice communication network system maximize the utilization of the transmission resources of the IP network and eliminate the causes (e.g., network delay, congestion influence) of the voice data quality deterioration when performing the voice data transmission. It is possible that the quality of the voice data transmitted over the IP network be maintained at an appropriate level without being affected by the network delay or the congestion.

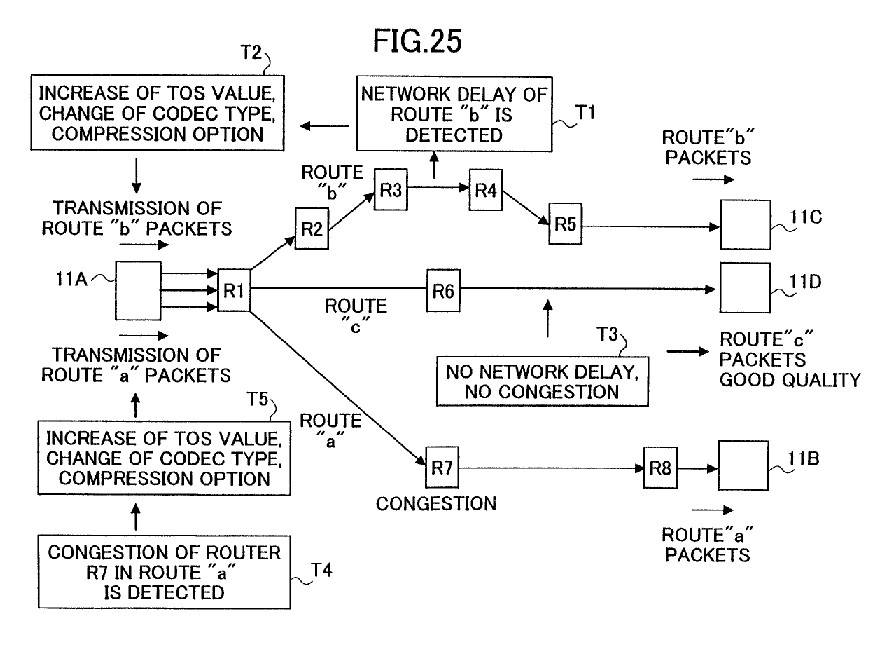

FIG. 25 shows operation of the voice communication network system in which the VoIP gateway apparatuses 11A, 11B, 11C and 11D according to the invention are provided.

Suppose that, in the example of FIG. 25, the VoIP gateway apparatus 11A is the sender VoIP gateway apparatus (which is called the sender station 11A) and the VoIP gateway apparatuses 11B-11D are the receiver VoIP gateway apparatuses (which are called the receiver stations 11B-11D). Usually, in the IP network, various intermediate routers are provided for the voice data transmission between a sender station and a receiver station. In the example of FIG. 25, the intermediate routers R1, R7 and R8 are in the route “a” between the sender station 11A and the receiver station 11B, the intermediate routers R1, R2, R3, R4 and R5 are in the route “b” between the sender station 11A and the receiver station 11C, and the intermediate routers R1 and R6 are in the router “c” between the sender station 11A and the receiver station 11D.

As described earlier, in the VoIP gateway apparatus (the sender station) 11A according to the present invention, at least one of the VDQ estimation unit 14, the RTCP estimation unit 15 and the TTL estimation unit 16 determines the network-state information of the IP network. It is supposed that, in the example of FIG. 25, the sender station 11A detects a network delay in the route “b” by using the functions of the VDQ estimation unit 14, the RTCP estimation unit 15 and the TTL estimation unit 16 (T1). In such a case, the CP determination unit 17 determines the increase of the ToS transmission priority level, the change of the CODEC type level (low bit rate) and the non-voiced data compression option when performing the transmission of the route “b” packets (T2). Hence, it is possible to maintain the quality of the voice data transmitted via the route “b” at an appropriate level without being affected by the network delay.

Further, it is supposed that, in the example of FIG. 25, the sender station 11A detects a congestion state of the router R7 in the route “a” by using the functions of the VDQ estimation unit 14, the RTCP estimation unit 15 and the TTL estimation unit 16 (T4). In such a case, the CP determination unit 17 determines the increase of the ToS transmission priority level, the change of the CODEC type level (low bit rate) and the non-voiced data compression option when performing the transmission of the route “a” packets (T5). Hence, it is possible to maintain the quality of the voice data transmitted via the route “a” at an appropriate level without being affected by the congestion state.

Further, it is supposed that, in the example of FIG. 25, the sender station 11A detects that there is no congestion state or no network delay in the route “c” by using the functions of the VDQ estimation unit 14, the RTCP estimation unit 15 and the TTL estimation unit 16 (T3). In such a case, the CP determination unit 17 does not change the control parameter (CP) level to control the encoding of the CODEC processing unit 12 and the packetizing of the IP packet processing unit 13.

Accordingly, the voice communication network system which utilizes the VoIP gateway apparatus of the present invention is effective in performing the voice data transmission to maximize the utilization of the network resources and maintain the quality of the voice data at an appropriate quality level without being affected by the network delay or the congestion state.

The present invention is not limited to the above-described embodiments, and variations and modifications may be made without departing from the scope of the present invention.

Further, the present invention is based on Japanese priority application No. 2001-102176, filed on Mar. 30, 2001, the entire contents of which are hereby incorporated by reference.

What is claimed is:

1. A gateway apparatus which interconnects a first network and a second network, comprising:
an encoding processing unit receiving voice data from the first network and generating encoded voice data from the received voice data;
a packet processing unit creating packets of the encoded voice data from the encoding processing unit and transmitting the packets to the second network;
a network-state estimation unit determining network-state information of the second network; and
a determination unit controlling at least one of the encoding of the encoding processing unit and the packetizing of the packet processing unit based on the network-state information determined by the network-state estimation unit.

2. The gateway apparatus according to claim 1, wherein the determination unit determines a type of the encoding that is performed by the encoding processing unit, based on the network-state information of the second network.

3. The gateway apparatus according to claim 1, wherein the determination unit determines an option of non-voiced data compression or non-compression that is performed by the encoding processing unit, based on the network-state information of the second network.

4. The gateway apparatus according to claim 1, wherein the determination unit determines a packet discarding priority level of the packet processing unit, based on the network-state information of the second network.

5. The gateway apparatus according to claim 1, wherein the determination unit determines a packet transmission priority level of the packet processing unit, based on the network-state information of the second network.

6. The gateway apparatus according to claim 1, wherein the network-state estimation unit determines a packet loss ratio based on packets that are received from a second gateway apparatus via the second network, and sends the packet loss ratio to the determination unit.

7. The gateway apparatus according to claim 6, wherein the determination unit stores at least one reference value of the packet loss ratio, and determines a specific one of a set of predetermined control parameter levels based on the result of comparison of said at least one reference value and the packet loss ratio received from the network-state estimation unit, the set of predetermined control parameter levels being inclusive of at least one of a set of packet discarding priority levels, a set of packet transmission priority levels, and a set of encoding type levels.

8. The gateway apparatus according to claim 1, wherein the network-state estimation unit determines a packet arrival time jitter based on packets that are received from a second gateway apparatus via the second network, and sends the packet arrival time jitter to the determination unit.

9. The gateway apparatus according to claim 8, wherein the determination unit stores at least one reference value of the packet arrival time jitter, and determines a specific one of a set of predetermined control parameter levels based on the result of comparison of said at least one reference value and the packet arrival time jitter received from the network-state estimation unit, the set of predetermined control parameter levels being inclusive of at least one of a set of packet discarding priority levels, a set of packet transmission priority levels, and a set of encoding type levels.

10. The gateway apparatus according to claim 1, wherein the network-state estimation unit reads a TTL value from a packet that is received from a second gateway apparatus via the second network at a start of communication, the network-state estimation unit sending the TTL value to the determination unit.

11. The gateway apparatus according to claim 10, wherein determination unit stores at least one reference value of the TTL value, and determines a specific one of a set of predetermined control parameter levels based on the result of comparison of said at least one reference value and the TTL value received from the network-state estimation unit, the set of predetermined control parameter levels being inclusive of at least one of a set of packet discarding priority levels, a set of packet transmission priority levels, and a set of encoding type levels.

12. The gateway apparatus according to claim 1, further comprising a network-state storage unit storing the network-state information with respect to each of a plurality of destination stations in the second network, wherein the determination unit stores a reference value of one of a packet loss ratio and a packet arrival time jitter, and, when a call connection between the gateway apparatus and one of the plurality of destination stations is established, the determination unit determines a specific one of a set of predetermined control parameter levels based on the result of comparison of the reference value and the network-state information of said one of the plurality of destination stations read from the network-state storage unit.

13. The gateway apparatus according to claim 1, wherein the network-state estimation unit transmits test voice data to a second gateway apparatus via the second network, receives test packets from the second gateway apparatus via the second network, and determines the network-state information, including an estimated network delay and an estimated voice data quality level, based on the result of comparison of the test voice data and the test packets.

14. The gateway apparatus according to claim 13, wherein the network-state estimation unit compares a transmission time of the test voice data and a receiving time of the test packets, and calculates an estimated network delay of the second network based on the result of the comparison of the transmission time and the receiving time.

15. The gateway apparatus according to claim 13, wherein the network-state estimation unit determines at least one of a packet loss ratio and a packet arrival time jitter of the second network based on the received test packets.

16. The gateway apparatus according to claim 13, wherein the encoding processing unit receives the test voice data from the network-state estimation unit, and generates pulse-code-modulation encoded voice data from the received test voice data.

17. A data transmission method which is performed by a gateway apparatus including an encoding processing unit and a packet processing unit and interconnecting a first network and a second network, the data transmission method comprising the steps of:
causing the encoding processing unit to receive voice data from the first network and generate encoded voice data from the received voice data;
causing the packet processing unit to create packets of the encoded voice data and transmit the packets to the second network;
determining network-state information of the second network; and
controlling at least one of the encoding of the encoding processing unit and the packetizing of the packet processing unit based on the network-state information obtained in the generating step.
